(19) United States
(12) Patent Application Publication
(10) Pub. No.: US 2021/0017302 A1
(43) Pub. Date: Jan. 21, 2021

(54) PRINTABLE RESINS AND USES OF SAME

(71) Applicant: The Research Foundation for The State University of New York, Amherst, NY (US)

(72) Inventors: Chong CHENG, Williamsville, NY (US); Javid RZAYEV, Williamsville, NY (US); Chi ZHOU, Getsville, NY (US); Jason SCHOFIELD, Williamsville, NY (US)

(21) Appl. No.: 16/917,181

(22) Filed: Jun. 30, 2020

Related U.S. Application Data
(63) Continuation-in-part of application No. PCT/US2018/068227, filed on Dec. 31, 2018.
(60) Provisional application No. 62/612,361, filed on Dec. 30, 2017.
(60) Provisional application No. 62/870,595, filed on Jul. 3, 2019.

(51) Int. Cl. C08F 2/50; C08F 220/20; C08F 220/28; C08F 220/34; C08F 220/56; C08F 236/20; C08K 5/00; C08K 5/205; C08K 5/08; C08K 5/5397; C08K 3/36; C08K 3/40; C08L 33/08

(52) U.S. Cl. CPC C08F 2/50; B33Y 70/00; C08F 220/286; C08F 220/34; C08F 220/56; C08F 236/20; C08K 5/0025; C08K 5/205; C08K 5/08; C08K 5/5397; C08K 3/36; C08K 3/40; C08L 33/08; C08F 2800/20; C08K 2201/005; C08K 2201/011; C08F 220/20

(57) ABSTRACT

Provided are resin compositions, which may be used for 3D printing. The resins may be colorless and/or transparent. The resins include a photoinitiator and one or more hard cross-linker. The resins may also include one or more of soft cross-linker(s), reactive diluent(s), filler(s), and additive(s). Also provided are articles of manufacture and methods of making articles of manufacture using one or more of the resins. The articles of manufacture may have one or more desirable mechanical and/or one or more desirable biocompatibility properties. The articles of manufacture may be colorless and/or transparent. The articles of manufacture may be produced using a method of the present disclosure.

### CROSS REFERENCE TO RELATED APPLICATIONS

This application is a continuation-in-part of International Application No. PCT/US2018/068227, filed on Dec. 31, 2018, which claims priority to U.S. Provisional Application No. 62/612,361, filed on Dec. 30, 2017, the disclosures of which are hereby incorporated by reference. This application also claims priority to U.S. Provisional Application No. 62/870,595, filed on Jul. 3, 2019, the disclosure of which is hereby incorporated by reference.

### FIELD OF THE DISCLOSURE

The disclosure generally relates to printable resins. More particularly, the disclosure generally relates to optically transparent and colorless 3D printable resins and uses of same.

### BACKGROUND OF THE DISCLOSURE

3D-Printing technology has revolutionized industrial manufacturing. In particular, 3D-printing through digital light processing (DLP)-based stereolithography (SLA) technology has been employed to produce many complex and customized products in precise and cost-effective manner. DLP-SLA 3D-printing can be the ideal technology for the manufacture of personalized healthcare products, including but not limited to, clear dental aligners. Accordingly, there is an evident market need for the development of formulations for 3D-printing of biocompatible resins. A broad variety of dental restorative materials have been developed and commercialized. Dental restorative materials generally possess a range of attractive properties, including high photocurability, remarkable biocompatibility (as approved by FDA or other related public health agencies), significant mechanic strength and tunable transparency. Among these properties, high photocurability is needed by resin formulations for DLP-SLA 3D-printing; biocompatibility is required for all healthcare products that contact living tissue during applications; significant mechanic strength and tunable transparency are also desired for many healthcare products.

Based on the foregoing, there is an ongoing and unmet need for improved printable resins.

### SUMMARY OF THE DISCLOSURE

The present disclosure provides resin compositions, objects (e.g., 3D objects) formed from a photocured resin compositions, and uses thereof. The present disclosure also provides uses of resin compositions.

This disclosure relates to 3D-printable biocompatible resin compositions that can produce clear optically clear and colorless materials (e.g., objects). In various examples, a resin composition was developed that can be printed into a 3-dimensional (3D) object (such as, for example, a dental aligner), for example, using a DLP-SLA printer using a 405 nm or a 365 nm light source.

In an aspect, the present disclosure provides resin compositions. The resin compositions can be used to form objects (e.g., 3D objects) by, for example, 3D printing. The resin compositions comprise one or more photoinitiator and one or more hard cross-linker. In various examples, a resin composition further comprises additional components chosen from soft cross-linkers, reactive diluents, fillers, additives, and combinations thereof. It is desirable that the resin is biocompatible. In various examples, a resin composition comprises one or more photoinitiator and one or more hard cross-linker and one or more soft cross-linker (e.g., a long soft cross-linker) or one or more reactive diluent. In various examples, a resin composition comprises one or more photoinitiator and one or more hard cross-linker and one or more soft cross-linker and one or more reactive diluent.

In an aspect, the present disclosure provides uses of resin compositions of the present disclosure. The resin compositions can be used to make printed objects (e.g., 3D printed objects using, for example, 3D printing methods such as, for example, DLP-SLA 3D-printing and the like). Suitable 3D printing methods are known in the art. The methods are based on the irradiation and photopolymerization of a layer of a resin composition of the present disclosure.

In an aspect, the present disclosure provides objects formed from resin compositions of the present disclosure. The objects can be three-dimensional (3D) objects. In various examples, an object (e.g., a 3D object) is formed of the present disclosure (e.g., by a method of the present disclosure). Non-limiting examples of objects include dental objects, hearing aids, and sleep apnea devices. The objects (e.g., 3D objects) may be formed using a resin composition of the present disclosure. Also described herein are methods for treating a subject's teeth.

In an aspect, the present disclosure provides a method of making an object (an article of manufacture) of the present disclosure. In various examples, a method is carried out using a resin composition of the present disclosure and/or to produce an object (an article of manufacture) of the present disclosure. In various examples, a method of making an object (e.g., a dental aligner) comprises one or more or all of the following: scanning, designing, and printing.

### BRIEF DESCRIPTION OF THE FIGURES

For a fuller understanding of the nature and objects of the disclosure, reference should be made to the following detailed description taken in conjunction with the accompanying figures.

FIG. 1 shows an examples of a rectangular 3D printed resin sample (size: 20×10×0.5 mm) printed from 50:48:2:1 mass ratio of 2-hydroxyethyl methacrylate (HEMA): diurethane dimethacrylate (UDMA):polysorbate 80 (P80):diphenyl(2,4,6-trimethylbenzoyl)phosphine oxide (TPO) after printing (left figure) and a control sample without the addition of P80 (right figure, showing a liquid composition droplet on surface).

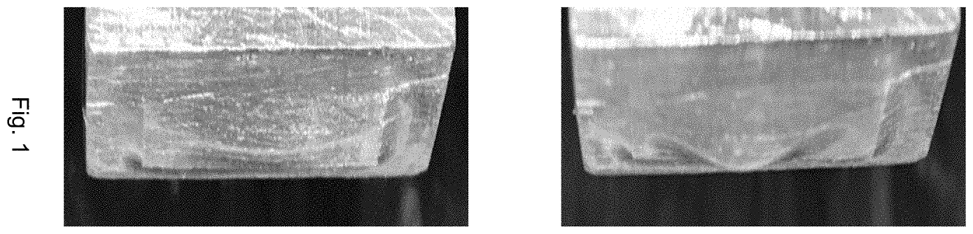

FIG. 2 shows an example of an orthodontic aligner formed using a resin of the present disclosure.

FIG. 3 shows an example of a model orthodontic aligner with supports.

### DETAILED DESCRIPTION OF THE DISCLOSURE

Although claimed subject matter will be described in terms of certain embodiments and examples, other embodiments and examples, including embodiments and examples that do not provide all of the benefits and features set forth herein, are also within the scope of this disclosure. Various structural, logical, and process step changes may be made without departing from the scope of the disclosure.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

Unless otherwise indicated, weight percent (wt %) as used herein refers to weight percent based on the total weight of the resin composition.

Unless otherwise indicated, room temperature as used herein refers to temperatures of 18-25° C., including 18, 19, 20, 21, 22, 23, 24, and 25° C.

The present disclosure provides resin compositions, objects (e.g., 3D objects) formed from a photocured resin compositions, and uses thereof. The present disclosure also provides methods of using resin compositions.

This disclosure relates to 3D-printable biocompatible resin compositions that can produce optically clear and colorless materials (e.g., objects). By optically clear and colorless materials (e.g., objects) as used herein with regard to objects, it is meant that an object exhibits at least a transmittance (transparency) as described herein. In various examples, the compositions are based on components that have been used in dental restorative materials. In various examples, a resin composition was developed that can be printed into a 3-dimensional (3D) object (such as, for example, a dental aligner), for example, using a DLP-SLA printer using a 405 nm or a 365 nm light source. Most commercial 3D DLP-SLA printers use a 405 nm LED/Laser/lamp light source.

Desirable attributes of photocured (3D printed) resins of the present disclosure (e.g., objects of the present disclosure) include:

1) Optically transparent, colorless (e.g., exhibiting at least a transmittance (transparency) as described herein) with a smooth surface (important for dental aligner applications due to aesthetics);
2) Flexural strength (for example, a flat piece can be bent over 90 degree without breaking and recovers its original state when force is released); and
3) Biocompatible components previously used in other medical devices (e.g. dental restorative materials).
In various examples, the photocured (e.g., 3D printed) resin of the present disclosure exhibits one or more of these desirable attributes.

In an aspect, the present disclosure provides resin compositions. The resin compositions can be used to form objects (e.g., 3D objects) by, for example, 3D printing.

The resin compositions comprise one or more photoinitiator and one or more hard cross-linker. In various examples, a resin composition further comprises additional components chosen from soft cross-linkers, reactive diluents, fillers, additives, and combinations thereof. It is desirable that the resin is biocompatible.

In various examples, a resin composition comprises one or more photoinitiator and one or more hard cross-linker and one or more soft cross-linker (e.g., a long soft cross-linker) or one or more reactive diluent. In various examples, a resin composition comprises one or more photoinitiator and one or more hard cross-linker and one or more soft cross-linker (e.g., a long soft cross-linker) and one or more reactive diluent. Typical loading of soft cross-linker and/or reactive diluent is 25-80 wt %, including all 0.1 wt % values and ranges therebetween.

Various photoinitiators can be used. It is desirable that can be activated by 405 nm or 365 nm light and not add significant color to the product (e.g., object) (e.g., the object exhibits transmittance (transparency) as described herein). Suitable photoinitiators include those typically used in dental restorative materials including, but are not limited to, the dental-specialty photoinitiators commercially available from Aldrich. Finding an initiator that is activated by 405 nm LED (used in commercial printers) but produces a colorless resin is a challenge because of the proximity of this wavelength to the visible range. For DLP-SLA 3D-printing using blue light irradiation (λₘₐₓ=405 nm), it was found that diphenyl(2,4,6-trimethylbenzoyl)phosphine oxide (TPO, CAS#75980-60-8) is a desirable choice because it has high photoinitiation efficiency and produces colorless resins. 1-Phenyl-1,2-propanedione/triame (PPD/TA) photoinitiating system is not as efficient as TPO, and PPD also has pale yellow color. Camphoroquinone has also pale yellow color. For DLP-SLA 3D-printing using UV irradiation (λₘₐₓ=365 nm), there are a number of different colorless photoinitiators available. Typical loading is 0.5-3 wt %, including all 0.1 wt % values and ranges therebetween.

Various hard cross-linkers can be used. Without intending to be bound by any particular theory, it is considered that a hard cross-linker is responsible for cross-linked network formation and mechanical strength. A hard cross-linker is a molecule that contains two or more polymerizable groups (e.g., acrylates, methacrylates, acrylamides, methacrylamides, and the like, with two or more polymerizable groups) and small molecular weight (e.g., less than 500 g/mol) and typically contains aromatic and/or hydrogen bonding groups. It is desirable that the hard cross-linker is colorless and/or results in low shrinkage during polymerization and/or has relatively low viscosity to facilitate the printing process. A desirable choice for this component is UDMA (diurethane dimethacrylate, (bis(2-methacryloxyethyl) N, N′-1, 9-nonylene biscarbamate, CAS#72869-86-4). Concentration of UDMA in the resin composition may be important. Without intending to be bound by any particular theory, it is considered that below 20 wt % UDMA the integrity of the resin is compromised during the printing process (e.g., Example 1). Above 75%, the viscosity of the resin may be too high, which compromises the 3D printing process, while the cured resin may be too hard/rigid. In an example, a resin composition comprises UDMA at 20-75 wt %, including all 0.1 wt % values and ranges therebetween. Other non-limiting examples of hard cross-linkers include bisphenol A derivatives, such as, for example, bisphenol A diglycidildimethacrylate (BisGMA). UDMA was desirable due to its lower viscosity.

In an example, a hard cross-linker is a cross-linker that, as the sole cross-linker without the presence of any reactive diluent, when cured to result in a rigid resin (a rigid material) with a glass transition temperature (T_{g}) substantially greater than room temperature and/or that does not exhibit a glass transition temperature. In an example, the rigid resin has a glass transition temperature of 50° C. or greater.

Various soft cross-linkers can be used. Soft cross-linkers are optional components in the resin compositions. Without intending to be bound by any particular theory, it is considered that a soft cross-linker imparts elasticity (flexibility). A soft cross-linker is a molecule that contains two or more polymerizable groups. A soft cross-linker may comprise a flexible polymer or oligomer chain, whose glass transition (T_{g}) is below room temperature. Soft cross-linkers can be of variable lengths (longer cross-linker typically results in a more flexible material). In an example, a soft cross-linker has a molecular weight of 500-4000 g/mol, including all 0.1 g/mol values and ranges therebetween. Suitable soft cross-linkers may be based on polyethylene glycol (PEG), polypropylene glycol (PPG), polydimethylsiloxane (PDMS) with reactive end groups (e.g., acrylate or methacrylate). Non-limiting examples of soft cross-linkers include PEG-based cross-linkers such as, for example, polyethylene glycol dimethacrylate (PEGDM, CAS#25852-47-5), polyethylene glycol diacrylate (PEGDA, CAS#26570-48-9), and Bisphenol A ethoxylate diacrylate (EBPADMA, CAS#64401-02-1). Desirable results were obtained with longer soft cross-linkers (number of repeat units, such as, for example, ethylene glycol, propylene glycol, and the like) of 8 or greater or 10 or greater) such as, for example, PEGDA (500 g/mol, e.g., Example 2) PEGDM (1000 g/mol, e.g., Example 3), EBPADMA (1700 g/mol, e.g., Example 4). When short (number of repeat units less than 8 or less than 10) PEG-based or PPG-based soft cross-linkers were used, such as tetraethylene glycol dimethacrylate (TEGMA), hard and brittle materials were obtained (e.g., Example 5). Desirable results were obtained by using long soft cross-linkers (soft cross-linkers with 8 or more or 10 or more repeat units, such as, for example, ethylene glycol repeat units, propylene glycol repeat units, or a combination thereof), because those provide both flexibility and toughness.

In an example, a soft cross-linker is a cross-linker which, as the sole cross-linker without the presence of any reactive diluent, when cured to result in a soft resin (with up to full conversion of reactive groups) with a glass transition temperature close to or lower than room temperature (e.g., a glass transition temperature of 30° C. or lower).

Various reactive diluents can be used. Reactive diluents are optional components in the resin compositions. A reactive diluent may be used in combination with or instead of soft cross-linker(s). Without intending to be bound by any particular theory, it is considered that a reactive diluent provides flexibility and/or helps lower the viscosity of the composition. A reactive diluent is typically a small molecule (e.g., less than 500 g/mol) with only one reactive group. Non-limiting examples of reactive diluents include 2-hydroxyethyl methacrylate (HEMA, CAS#868-77-9), polyethylene glycol methacrylate (PEGMA), (2-dimethylaminoethyl) methacrylate (DMAEMA), and other acrylate or methacrylate monomers typically used in dental restorative materials. Multiple monomers can be used together or in combination with soft cross-linkers in a resin composition (e.g., Examples 6, 7, and 8).

2-Hydroxyethyl methacrylate (HEMA) is a desirable choice of reactive diluent, because it is inexpensive and can result in hydrophilic biocompatible structural units without undesirable volume shrinkage. However, because HMEA homopolymer has glass transition temperature (T_{g}) well above ambient temperature, compositions with high HEMA amounts can result in glassy resins. The combination of HEMA with other monomers which correspond to homopolymers having low T_{g} can increase toughness of the cured materials. For example, (2-dimethylaminoethyl) methacrylate (DMAEMA) corresponds to homopolymer PDMAEMA with T_{g} of 19° C., and relative to HEMA with the same total wt %, HEMA-DMAEMA combinations lead to tougher materials (e.g., Example 1). Although methyl methacrylate (MMA) is a commonly used methacrylate monomer, it is typically not desirable as the majority monomer for 3D-printing applications because it may involve significant volume shrinkage during polymerization.

Various fillers can be used. Fillers are optional components in the resin compositions. The compositions used in dental restorative materials include dental-specialty fillers commercially available from Aldrich. The comprehensive mechanical properties of resin may increase when appropriate fillers are used. The addition of fillers does not necessarily significantly decrease the transparency of the resulting resins, and the principles of minimizing turbidity of dispersions to achieve transparency are known. When transparency of resins needs to be maintained, silicon nanoparticles (e.g., silica nano-powders) (diameters less than 50 nm) is a desirable choice of filler because silicon has refractive index close to the polymer matrix while the nano-sizes reduce light scattering and enhance colloidal stability (e.g., Example 9). In various examples, silicon nanoparticles (e.g., silicon nano-powder) are used up to 20 wt %, including all 0.1 wt % values and ranges therebetween. In various examples, a resin composition comprises silicon nanoparticles (e.g., silicon nano-powder) at 0.1-20 wt %, including all 0.1 wt % values and ranges therebetween.

A resin composition may comprise one or more other additives. Other additives can be used to improve printing resolution. Non-limiting examples of other additives include photoblockers, surfactants, and the like.

Typically, photoblockers are not used in dental restorative materials. However, to increase 3D-printing accuracy, it is optional to use photoblocker, along with photoinitiator. With the consideration of biocompatibility issue, biocompatible photoblockers with significant absorptions at light wavelength for DLP-SLA 3D-printing (but are colorless) are desirable. Non-limiting examples of photoblockers include chlorophyll, anthocyans, folic acid, and the like, and combinations thereof. For example, chlorophyll has strong absorption peak at ˜405 nm, and can effectively serve as photoblocker for DLP-SLA 3D-printing using light at this wavelength. In addition, anthocyans can serve as photoblockers due to their absorption of blue light. Both chlorophyll and anthocyans are nature-occurring chemicals. Another example, is folic acid, which has a weak absorption at 405 nm, but has an advantage of being biocompatible.

Typically, surfactants or wetting agents are not used in dental restorative materials. It is optional to use surfactants and/or wetting agents in resin compositions of the present disclosure. The use of surfactants and/or wetting agents is desirable for 3D printing processes, if in their absence the composition viscosity is undesirably high; surfactants and/or wetting also help minimize the surface attachment of liquid compositions when printing is completed. Among biocompatible surfactants or wetting agents, poly(ethylene glycol)-containing neutral surfactants are desirable choices. For instance, the addition of 2 wt % of polysorbate 80 (P80) can significantly decrease the viscosity of a viscous composition and reduce remaining composition on printed resin surface (e.g., Example 10). Because surfactant can also essentially serve as plasticizer in plastic resin, the use of surfactant in resin composition can also increase the toughness of the printed resin sample (e.g., Example 11). When a surfactant and/or wetting agent is used, a desirable weight range of surfactant in a resin composition is 0.5-5 wt %, including all 0.1 wt % values and ranges therebetween.

The resin compositions (or objects formed from the resin compositions) can exhibit desirable optical properties (e.g., absorption and/or transmittance of visible light). The resin compositions can be optically clear and colorless. By optically clear and colorless with regard to resin compositions, it is meant that an object exhibits at least an absorbance and/or transmittance of visible light as described herein. In an example, a resin composition absorbs 2% or less (e.g., 1% or less or 0.5% or less) of one or more wavelengths of visible light (e.g., electromagnetic energy having a wavelength of 420-800 nm) passed through 1 millimeter of the composition and/or the composition exhibits a transmittance of 90% or greater (e.g., 95% or greater, 98% or greater, or 99% or greater) of one or more wavelengths of visible light (e.g., 390-700 nanometer wavelengths) passed through 1 millimeter of the composition.

In an aspect, the present disclosure provides uses of resin compositions of the present disclosure. The resin compositions can be used to make printed objects (e.g., 3D printed objects using, for example, 3D printing methods such as, for example, DLP-SLA 3D-printing). The objects are also referred to herein as articles of manufacture. Suitable 3D printing methods are known in the art. The methods are based on the irradiation and photopolymerization of a layer of a resin composition of the present disclosure.

As an example of a general description of a method for making a printed object, a resin composition is poured into a container and is exposed to light having one or more selected wavelengths through a mask in a layer by layer fashion (e.g., a 3D printing process). The printed object is then removed and treated to obtain a smooth and finished surface.

For example, a method of making an object (e.g., a 3D object) comprises: exposing a first layer of a resin composition of the present disclosure (e.g., a resin composition of any one of Statements 1-19) to electromagnetic radiation (e.g., electromagnetic radiation having a wavelength of 365 nm or 405 nm) such that at least a portion of the first layer of a resin composition reacts to form a polymerized portion of the first layer; optionally, forming a second layer of a resin composition of the present disclosure (e.g., a resin composition of any one of Statements 1-19) disposed on at least a portion of the polymerized portion of the previously formed polymerized portion and exposing the second layer of a resin composition to electromagnetic radiation (e.g., electromagnetic radiation having a wavelength of 365 nm or 405 nm) such that at least a portion of the second layer of a resin composition reacts to form a second polymerized portion of the second layer disposed on the polymerized portion of the first layer; and optionally, repeating the forming and exposing a desired number of times, where the object (e.g., the 3D object) is formed.

The exposing (or irradiation) of a resin composition layer can be performed as a blanket (i.e., flood) exposure or a patterned (e.g., lithographic or direct write) exposure. For example, the exposing is carried out using stereolithography. Electromagnetic radiation used in the exposing may have a wavelength or wavelengths from 300 to 800 nm, including all integer values and ranges therebetween. In various examples, it is desirable the exposing (or irradiation) is carried out using electromagnetic radiation comprising a wavelength of 365 nm or 405 nm. In various examples, the exposing (or irradiation) is carried out using UV LED lights or lasers (e.g., such as those found in Ember by Autodesk and Formlabs 1, 1+ and 2 printers (405 nm)) or mercury and metal halide lamps (e.g., such as those found in high definition projectors (300-800 nm)).

The exposing (or irradiation) of a resin composition layer can be carried out for various times. In various examples, the exposing (or irradiation) is carried out for 0.2-20 seconds, including all 0.1 second values and ranges therebetween. A required exposure time depends on print parameters such as, for example: layer height, cross sectional area, power intensity of the printer, wavelength of light source, concentration of photoinitiator, and the like.

The thickness of the layer(s) of resin composition can vary. For example, the thickness of the layer(s) of polymer composition are, independently, from 0.1 microns to 10,000 microns, including all 0.1 micron values and ranges therebetween.

The methods (e.g., exposing and/or layer formation) can be carried out with a 3D printer. Examples of types of 3D printers include, but are not limited to, Digital Mask Projection stereolithography (e.g., Ember by Autodesk, Phoenix Touch Pro UV DLP SLA), micro-stereolithography printers, and laser based direct-write stereolithography systems (e.g., FormLabs form 1, 1+, and 2, Pegasus Touch Laser SLA, Materialise Mammoth).

Methods of making objects can include one or more post-printing processes/treatments. Non-limiting examples of post-printing processes/treatments include: additional photocuring under inert gas (e.g., nitrogen): this treatment completes the curing process, and when conducted under inert gas, provides a smooth finish; soaking in water or other solvents: this treatment removes uncured material from the surface and provides a smooth finish; and coating the product with a thin layer of composition (for example, naturally or with a brush) followed by additional photocuring under inert atmosphere: this treatment smoothens the surface roughness and provides a finished flat surface.

In an aspect, the present disclosure provides objects formed from resin compositions of the present disclosure. The objects can be three-dimensional (3D) objects. In various examples, an object (e.g., a 3D object) is formed of the present disclosure (e.g., by a method of the present disclosure).

The objects (e.g., 3D objects) are formed using a resin composition of the present disclosure. In various examples, the object (e.g., 3D object) is biocompatible. In various examples, the object (e.g., 3D object) is transparent and clear. In various examples, the object (e.g., 3D object) is biocompatible, transparent, and clear. In various examples, the object (e.g., 3D object) is a dental object, a hearing aid, or a sleep apnea device. Non-limiting examples of dental objects include dental restorations, dental aligners, and the like.

Non-limiting examples of dental restorations include full-contour FPDs (fixed partial dentures), bridges, implant bridges, multi-unit frameworks, abutments, crowns, partial crowns, veneers, inlays, onlays, orthodontic retainers, aligners, space maintainers, tooth replacement appliances, splints, dentures, posts, teeth, jackets, facings, facets, implants, cylinders, and connectors.

In an example, a 3D object is a dental aligner (e.g., a biocompatible dental aligner). A dental aligner of the present disclosure is generally intended to move a subject's teeth from an initial configuration to a final configuration. Thus, an aligner can be used to straighten teeth or correct malocclusion. In various examples, a dental aligner is configured to move a subject's teeth from an initial configuration to a final configuration, to straighten teeth, or correct malocclusion. A dental aligner can move the subject's teeth by rotating and/or translating the subject's teeth. For example, the dental aligners rotate at least one of the subject's teeth in one or more directions around its roots when the aligner is worn by the subject. In an example, a dental aligner is configured to rotate at least one of the subject's teeth around its roots in one or more of: the polar direction, the azimuthal direction, and the self-rotation direction. In various examples, a dental aligner is configured to translate at least one (or more) of the subject's teeth in the x-direction, y-direction, and/or the z-direction.

In an example, a dental aligner comprises a shell formed using a resin composition of the present disclosure or a method of making an object of the present disclosure having the teeth-receiving cavity formed therein. In various examples, an individual dental aligner is configured so that its tooth-receiving cavity has a geometry corresponding to an intermediate or end tooth arrangement intended for that dental aligner. That is, when a dental aligner is first worn by a subject, certain of the teeth will be misaligned relative to an undeformed geometry of the appliance cavity. The dental aligner, however, is sufficiently resilient to accommodate or conform to the misaligned teeth, and will apply sufficient resilient force against such misaligned teeth in order to reposition the teeth to the intermediate or end arrangement desired for that treatment step.

Also described herein are methods for treating a subject's teeth. For example a method for treating a subject's teeth comprises determining an initial configuration of the subject's teeth, determining a final configuration of the subject's teeth, designing a movement path from the initial configuration to the final configuration for one or more of the subject's teeth, dividing the movement path into a plurality of treatment steps (each having a target configuration for the subject's teeth), producing receiving features on a dental base in response to the target configuration for the subject's teeth (the receiving features being configured to receive physical tooth models), assembling the physical tooth models on the dental base to form a physical arch model in the target configuration, and producing at least one dental aligner using a resin composition of the present disclosure or a method of making an object of the present disclosure using the physical arch model configured to move the subject's teeth to the target configuration.

In an aspect, the present disclosure provides methods of making an object (an article of manufacture) of the present disclosure. In various examples, a method is carried out using a resin composition of the present disclosure and/or to produce an object (an article of manufacture) of the present disclosure. Examples of methods of making an object are described herein.

In various examples, a method of making a dental aligner comprises one or more of the following: Scanning. In order to 3D print an aligner, use a scanner to collect anatomical data of the patient's dentition. Either scan the patient directly with an intraoral scanner, or use a desktop optical scanner to scan a polyvinyl siloxane (PVS) impression or stone model of a patient's teeth.

Designing. Design a clear aligner in dental CAD software. It is desirable to use software that offers open STL file export. The designing may use one or more of the following the guidelines below to ensure that the parts have sufficient strength and durability.

| Parameter | Values |
|---|---|
| Side wall thickness | 0.5-1.5 |
| Bottom/occlusal surface thickness | 0.5-1.5 |
| Offset (aka. “Block Out Undercuts Offset”) | 0.0-1.5 |

Additional block out settings, such as block out angle and retention, should be determined clinically by the doctor or the dental technician.

A few steps that may be important to take into consideration for 3D printing are:

Import & trim scans—both preparation and antagonist. First, import the scans (e.g., intraoral or desktop optical scans of the patient dentition) into a desired dental CAD software. Line marking or area selection tools may be used to remove erroneous scan data, and select only the portion of the dentition that will be printed.
Define insertion direction and block out undercuts. It is desirable to ensure that the model is blocked out adequately where needed, depending on the specifics of the case. Block out undercuts directly to impact the retention of the aligner. Undercuts may be blocked out after setting insertion direction and defining the desired block out parameters.
Generate initial aligner shell and apply. To design the aligner, spline tools may be used to mark the margin of the aligner along the perimeter of the arch. For example, an initial aligner design is generated, using a minimum thickness of 0.5 mm and an offset of 0.1 mm (which may vary). The design may be adjusted manually using standard sculpting tools if necessary.
Check design and make initial adjustments. Using inspection tools to ensure aligner is within specifications. Inspect the model to ensure that the part is designed properly. Adjust the design manually using standard sculpting tools, if necessary. Finalize the design by checking the occlusion and articulation of the model and aligner.
Export Designed File. Once the design is created, export a digital model of the part, for example, in STL or OBJ file format.

Printing.

Select material. For example, using Open Printer software, select the desired material from the material menu.

Import model files into the printer software. For example, import the STL or OBJ file into the printer software.

Orient models. Orient parts with the intaglio surfaces facing away from the build platform, to ensure that supports will not be generated on these surfaces. It is desirable to ensure that parts are oriented at an angle of 30° or less. Without intending to be bound by any particular theory, it is considered that orienting parts upright or at angles more than 30° could compromise precision and lead to poorly fitting parts. When angling the model in the nesting software, it may be desirable to rotate the anterior portion upward and away from the build platform so that the posterior ends remain closer to the build platform.

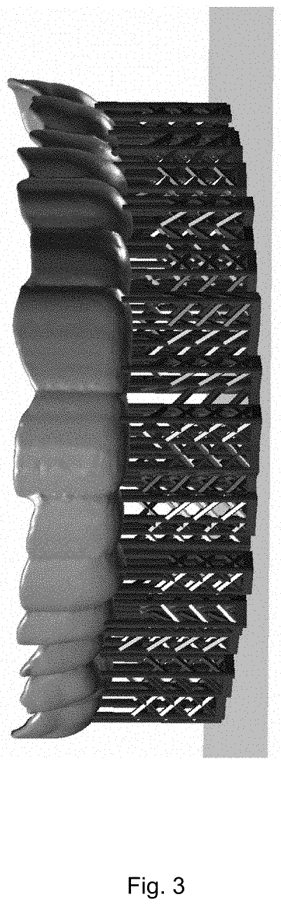

Generate Supports. Generate supports using printer software auto-generation feature. Inspect the part to ensure there are no support touchpoints on intaglio surfaces. Use the manual support editing feature to add or remove supports, if needed. An example of a model with supports is shown in FIG. 3.

Upload the print.

Prepare the printer and resin. Insert a resin tank, and build platform into the printer. If the resin is refrigerated pour into resin tank and bring to room temperature in a dark place.

Post-processing printed aligners. Post-processing 3D printed aligners primarily involves five steps: Use centrifuge to spin excess resin off of aligner and/or vacuum excess resin from voids, cure in nitrogen environment, removing supports, remove burs, and polishing.

Post-processing printed aligners may include one or more of the following:

Use centrifuge and/or vacuum excess resin from voids. Handle 3D printed part by the support structure as not to disturb the facial side of the aligner. Use centrifuge or vacuum pump to remove excess resin from voids on aligner. Optionally, turn the aligner upside down and let gravity remove the excess resin from the voids. Without intending to be bound by any particular theory, it is considered that post-curing outside of the process(es) described herein can lead to discoloration of aligner and undesired outcomes. For example, post-curing at too high a temperature, for too long a duration, or with too high intensity of light can lead to sub-optimal mechanical and bio-compatibility properties.

Post-curing parts with an alternative post-curing chamber and process.

It may be desirable that printed aligners be exposed to light to achieve bio-compatibility and optimal mechanical properties. Post-cure duration depends on the light intensity and the internal temperature of the post-curing device.

For example, post-curing is carried out using a flash curing box (an example of a flash curing box is show in FIG. 4) with nitrogen gas in a chamber. Non-limiting examples of a suitable flash curing specifications include:

### Curing Chamber Access: Top Loading

Operating Voltage: 100, 115, 230 volt AC, Selectable Nominal Frequency:50-60 Hz

### Power Input: About 250 W

Radiated/Flashed Lamp Power: About 200 W (100×/Lamp) Light Power: Ca. ⅓ of lamp power≈66 W

### Spectral Distribution: 300-700 nm, max 400-500

Light Power: Ca. ⅓ of lamp power≈11 W
Flash Rate: 10 flashes per second
Pure Nitrogen gas settings: Adjust flow control gauge to 10 psi; flow gas into chamber and set flash curing digital controls to 650 flashes place aligners inside the chamber; close the chamber door start flash sequence; and close the vessel around the post curing chamber so the nitrogen can reach a higher concentration level.
Once flash sequence has finished, let sit for two minutes, then flip aligner over. Flash part to 650 flashes.

Remove supports. Use caution when cutting the supports. Supports can also be removed using other specialized appliances, such as cutting disks or round cutting instruments like carbide burs.

Check fit. To check fit, print a solid model of the patient's dentition, and place the aligner on the model where necessary. Make adjustments to the 3D printed aligner or the post-processed parts if necessary. For printing orthodontic models, it may be desirable to use higher accuracy dental model resin.

Cleaning and disinfecting. Use an isopropyl alcohol solution to disinfect parts before use.

Optionally, wash parts with an ultrasonic bath. Remove parts from the build platform with a part removal tool. Rinse parts in isopropyl alcohol (IPA, 96% or higher) for two minutes in an ultrasonic bath to dissolve any uncured or excess resin. Transfer parts to a new bath of clean alcohol solution and rinse them for an additional three minutes in an ultrasonic bath. Leave parts to air dry completely, or use a compressed air hose to blow IPA away from parts' surfaces. Inspect parts closely to ensure all uncured resin has been removed. Repeat wash if necessary, but do not leave parts in alcohol for more than 10 minutes as this may cause reduced mechanical performance and defects in the printed parts.

The steps of the methods described in the various embodiments and examples disclosed herein are sufficient to carry out the methods of the present disclosure. Thus, in an example, a method consists essentially of a combination of steps of the methods disclosed herein. In another example, a method consists of such steps.

The following Statements describe various examples of the present disclosure, these examples are not intended to be limiting in any manner:

Statement 1. A resin composition comprising: one or more photoinitiator described herein; one or more hard cross-linker of the present disclosure (e.g., where the one or more hard cross-linker has at least two reactive groups and is present at 20-75 wt % (based on the total weight of the composition); and one or more soft cross-linker of the present disclosure (e.g., long soft cross-linker(s)) and/or one or more reactive diluent of the present disclosure (e.g., where the one or more soft cross-linker has at least two reactive groups is present at 2-70 wt % (based on the total weight of the composition) and/or the one or more reactive diluent has only one reactive group and is present at 2-70 wt % (based on the total weight of the composition)).
Statement 2. A resin composition according to any one of the preceding Statements, where the resin composition further comprises one or more soft cross-linker described herein and one or more reactive diluent described herein.
Statement 3. A resin composition according to any one of the preceding Statements, where the resin composition further comprises: one or more filler described herein; and/or one or more additive described herein (e.g., photoblocker(s), surfactant/wetting agent(s), or combination thereof).
Statement 4. A resin composition according to any one of the preceding Statements, where the one or more photoinitiator is diphenyl(2,4,6-trimethylbenzoyl)phosphine oxide (TPO), 1-phenyl-1,2-propanedione/triame (PPD/TA), camphoroquinone, Irgacure 819, henanthrenequinone, or a combination thereof.
Statement 5. A resin composition according to any one of the preceding Statements, where the hard cross-linker has a molecular weight of less than 700 g/mol (e.g., less than 500 g/mol) and, optionally, one or more aromatic group and/or one or more hydrogen-bonding group (e.g., groups with one or more oxygen atom and/or nitrogen atom (donor) that can form a hydrogen bond with a H atom (acceptor)).
Statement 6. A resin composition according to any one of the preceding Statements, where the one or more hard cross-linker is UDMA (diurethane dimethacrylate), (bis(2-methacryloxyethyl) N, N′-1, 9-nonylene biscarbamate), bisphenol A or a derivative thereof (e.g., bisphenol A diglycidildimethacrylate (BisGMA)), pyromellitic dianhydrate dimethacrylate, 1,1,1-tri-[4-(methacryloxyethylamino-carbonyloxy)-phenyl]ethane (MPE), or a combination thereof.
Statement 7. A resin composition according to any one of the preceding Statements, where the soft cross-linker when polymerized to a molecular weight (e.g., Mw or Mn) of 8,000-15,000 g/mol (e.g., about 10,000 g/mol) provides a polymer having a glass transition temperature (Tg) below or close to room temperature (e.g., a glass transition temperature (Tg) of 30° C. or less).
Statement 8. A resin composition according to any one of the preceding Statements, where the one or more soft cross-linker is polyethylene glycol dimethacrylate (PEGDM), polyethylene glycol diacrylate (PEGDA), polypropylene glycol dimethacrylate (PPGDMA), polypropylene glycol diacrylate (PPGDA) and bisphenol A ethoxylate diacrylate (EBPADA), which may have a molecular weight of 700 g/mol or greater, bisphenol-A ethoxylate dimethacrylate (EBPADMA), which may have a molecular weight of 700 g/mol or greater, tetraethylene glycol dimethacrylate (TEGDMA), polydimethyl siloxane dimethacrylate (PDMSDMA), polydimethyl siloxane diacrylate (PDMSDA), or a combination thereof.
Statement 9. A resin composition according to any one of the preceding Statements, where the one or more reactive diluent is chosen from acrylamides, methacrylamides, acrylates, methacrylates, and combinations thereof (e.g., 2-hydroxyethyl methacrylate (HEMA), polyethylene glycol methacrylate (PEGMA), polyethylene glycol acrylate (PEGA), (2-dimethylaminoethyl) methacrylate (DMAEMA) or a combination thereof).
Statement 10. A resin composition according to any one of the preceding Statements, where the one or more filler is a plurality of nanoparticles of the present disclosure (e.g., silica nano-powder, silicate glass nano-powder, polyhedral oligomer silsesquioxane (POSS) nano-powder, and the like) having no dimension greater than 100 nm (e.g., no dimension greater than 50 nm).
Statement 11. A resin composition according to any one of the preceding Statements, where the one or more additive is one or more photoblocker of the present disclosure (e.g., chlorophyll, anthocyans, folic acid, and combinations thereof), one or more surfactant/wetting agent (e.g., poly(ethylene glycol) or oligo(ethylene glycol)-containing neutral surfactants and combinations thereof), or a combination thereof.
Statement 12. A resin composition according to any one of the preceding Statements, where the one or more filler is present at 0.1-20 wt % (based on the total weight of the composition) and/or the one or more additive is present at 0.5-5 wt % (based on the total weight of the composition).
Statement 13. A resin composition according to any one of the preceding Statements, where the mass ratio of the one or more soft cross-linker to the one or more hard cross-linker is 1:9 to 9:1, including all ratios to 0.1 therebetween (e.g., 2:8 to 8:2).
Statement 14. A resin composition according to any one of the preceding Statements, where the composition absorbs 2% or less (e.g., 1% or less or 0.5% or less) of electromagnetic energy having a wavelength of 420-800 nm passed through 1 millimeter of the composition.
Statement 15. A resin composition according to any one of the preceding Statements, where the composition exhibits a transmittance of 90% or greater (e.g., 95% or greater, 98% or greater, or 99% or greater) of electromagnetic energy having visible wavelengths (e.g., 390-700 nanometer wavelengths) passed through 1 millimeter of the composition.
Statement 16. A resin composition according to any one of the preceding Statements, where the composition has a viscosity of 1 to 2000 cP (e.g., 2 to 2000 cP) at room temperature.
Statement 17. A resin composition according to any one of the preceding Statements, where the composition exhibits a minimum curing depth of 100 microns or less (e.g., 50 microns or less or 70 microns or less).
Statement 18. A resin composition according to any one of the preceding Statements, where the one or more photoinitiator is diphenyl(2,4,6-trimethylbenzoyl)phosphine oxide (TPO) and the one or more photoinitiator is present at 0.5-5 wt % (e.g., 1-3 wt. %); the one or more hard cross-linker is diurethane dimethacrylate (UDMA; CAS #72869-86-4) and the one or more hard cross-linker is present at 30-50 wt % (e.g., 35-45 wt. %); and the one or more soft cross-linker is polyethylene glycol diacrylate (PEGDA) and/or polyethylene glycol dimethacrylate (PEGDM) and the one or more soft cross-linker is present at 50-70 wt % (e.g., 55-65 wt. %).
Statement 19. A resin composition according to Statement 18, where the polyethylene glycol diacrylate (PEGDA) and/or polyethylene glycol dimethacrylate (PEGDM) a molecular weight of 400-1000 g/mol (e.g., 500-700 g/mol) (e.g., 575 g/mol).
Statement 20. An object (e.g., an article of manufacture) (which may be formed using a resin of any one of the preceding Statements), which may be a three-dimensional (3D) printed article of manufacture, of the present disclosure. The object (e.g., an article of manufacture) may exhibit one more of mechanical and/or one or more optical and/or one or more biocompatibility properties as described herein (e.g., exhibit one or more or all of the following: an elastic (Young's) modulus of at least 1500 MPa (e.g., at least 1 GPa); a tensile strength of at least 20 MPa (e.g., at least 25 or at least 30 MPa); and an ultimate elongation of at least 4% (e.g., at least 20%) and/or exhibiting greater than 85% (e.g., greater than 90%, greater than 95%, greater than 99%) transmittance (transparency) measured under ASTM D1003-13 using a 0.75 mm sample size, where the sample size is measured along the optical path the light is transmitted through the sample and/or a fracture toughness of greater than 80 J/m as measured under ISO180 and/or ASTM D256). For example, the 3D printed article of manufacture is a Class II dental device (e.g., an orthodontic aligner) and the article of manufacture exhibits a flexural strength at least meeting the requirements of ISO 20795-2 (e.g., exhibits 10 hours to 50% decrease in flexural strength), where the flexural strength is measured at 37° C., and a biocompatibility at least meeting the requirements of ISO 10993-5 and ISO 10993-10.
Statement 21. An object (e.g., an article of manufacture) of the present disclosure (which may be formed using a resin of any one of the preceding Statements) exhibiting one or more or all of the following properties:
a tensile strength/yield greater than 20 MPa measured under ISO 527-3, where the tensile strength/yield is measured at 23 to 37° C. in water;
an elastic (Young's) modulus greater than 1600 MPa measured under ISO 527-3, where the elastic (Young's) modulus is measured at 23 to 37° C. in water;
an elongation at break greater than 4% measured under ISO 527-3, where the elongation at break is measured at 23 to 37° C. in water;
an elongation at yield greater than 4% measured under ISO 527-3, where the elongation at yield is measured at 23 to 37° C. in water;
a tear strength of 40 N/mm or greater measured under the requirements of ISO 6383-1, where the tear strength is measured at 23 to 37° C. in water;
a flexural strength of 10% or justified measured under ISO 178, where the flexural strength is measured at 23 to 37° C. in water;
an impact strength of greater than 80 J/m measured under ISO 180 and/or ASTM D256;
a stress intensity factor greater than 4 MPa*m^{0.5} measured under ISO 20795-2, where the stress intensity factor is measured at 23 to 37° C. in water;
a notched impact strength of 16 KJK/m² measured under ISO 53453-1, where the notched impact strength is measured at 23 to 37° C. in water;
a cytotoxicity at least meeting the requirements of ISO 10993-5;
a sensitization at least meeting the requirements of ISO 10993-10;
a skin irritation at least meeting the requirements of ISO 10993-10;
a systemic toxicity at least meeting the requirements of ISO 10993-11; or a genotoxicity at least meeting the requirements of ISO 10993.
Statement 22. An object of Statement 20, where the object is a three-dimensional object.
Statement 23. An object of Statement 20 or Statement 21, where the object is a dental object, hearing aid, or sleep apnea device.
Statement 24. An object of Statements 22, where the dental object is dental restoration or dental aligner.
Statement 25. An object of Statement 23, where the dental restoration is chosen from an artificial tooth, full-contour FPDs (fixed partial dentures), bridges, implant bridges, multi-unit frameworks, abutments, crowns, partial crowns, veneers, inlays, onlays, orthodontic retainers, space maintainers, tooth replacement appliances, splints, dentures, posts, teeth, jackets, facings, facets, implants, cylinders, and connectors.
Statement 26. A method of making an object (e.g., a 3D object) comprising: a) exposing a first layer of a resin composition of the present disclosure (e.g., a resin composition of any one of Statements 1-19) to electromagnetic radiation (e.g., electromagnetic radiation having a wavelength of 350-420 nm, such as, for example, 365 nm or 405 nm) such that at least a portion of the first layer of a resin composition reacts to form a polymerized portion of the first layer; b) optionally, forming a second layer of a resin composition of the present disclosure (e.g., a resin composition of any one of Statements 1-19 disposed on at least a portion of the polymerized portion of the previously formed polymerized portion and exposing the second layer of a resin composition to electromagnetic radiation (e.g., electromagnetic radiation having a wavelength of 350-420 nm, such as, for example, 365 nm or 405 nm) such that at least a portion of the second layer of a resin composition reacts to form a second polymerized portion of the second layer disposed on the polymerized portion of the first layer; and c) optionally, repeating the forming and exposing from b) a desired number of times, where the object (e.g., the 3D object) is formed.
Statement 27. A method according to Statement 25, where the exposing and forming is carried out using a 3D printer.
Statement 28. A method according to Statement 25 or Statement 26, where the exposing and forming is carried out using stereolithography (e.g., DLP-SLA 3D-printing).
Statement 29. A method according to any one of Statements 25-27, where the object may be an aligner, sleep apnea device, or hearing aid, the method further comprising the following pre-printing processes: obtaining (e.g., by directly scanning the individual using, for example, an intraoral scanner, or by scanning an impression or mold of a portion of the individual (e.g., the teeth of the individual) using, for example, a desktop optical scanner, or the like) anatomical data (e.g., dental data) of an individual; designing the object (e.g., using CAD software); and creating a digital model of the aligner (e.g., a model comprising one or more supports), and/or the following post-printing (post curing) steps: removing (e.g., using a centrifuge and/or by exposing the object to vacuum and/or by contacting the object with water, one or more organic solvent, or a combination thereof) at least a portion or all of the unexposed resin from the object;
exposing the object to light (post-curing) having a wavelength of 300-700 nm (e.g., having a maximum wavelength intensity at 400-500 nm) under a nitrogen atmosphere (e.g., a static or dynamic nitrogen atmosphere); and removing the supports, if present, from the object.
Statement 30. A method according to Statement 29, where the exposing is carried out in a flash curing box (e.g., a flash curing box having one or more of the following features: operating voltage: 100, 115, 230 volt AC, selectable; nominal Frequency: 50-60 Hz; power input: about 250 W; radiated/flashed lamp power: about 200 W (100×/lamp); light power: about ⅓ of lamp power (e.g., about 66 W); spectral distribution: 300-700 nm, optionally, max 400-500 nm; light power: about ⅓ of lamp power (e.g., about 11 W); flash rate: 10 flashes per second; and nitrogen gas atmosphere (e.g., nitrogen flow of 10 psi), and the aligner is exposed to 650 flashes per side).

The following examples are presented to illustrate the present disclosure. They are not intended to limiting in any matter.

### Example 1

Resin composition containing UDMA:PEGMA (molecular weight 500 g/mol):HEMA at 20:20:60 wt % and 10:30:60 wt % with TPO as photoinitiator were prepared and used for 3D printing by DLP-SLA printer at 405 nm.

Both resulted in very soft and mechanical unstable films. When concentration of UDMA was increased to 40 wt % (e.g. UDMA:PEGMA (molecular weight 500 g/mol):HEMA=40:20:40 wt %), stable, colorless and transparent rectangular objects were successfully printed.

### Example 2

Three resin compositions containing various UDMA:PEGDA (molecular weight 575 g/mol) ratios were used to 3D print rectangular objects (size: 20×10×0.5 mm), using TPO as a photoinitiator (0.5 wt %).

### Sample 1: UDMA:PEGDA=60:40 wt %

### Sample 2: UDMA:PEGDA=50:50 wt %

### Sample 3: UDMA:PEGDA=40:60 wt %

All three samples produced transparent, colorless objects with significant flexibility and strength. The rectangular pieces were bent by 180 degrees multiple times without breaking. As the amount of PEGDA in the sample increased, the flexibility of the printed object increased (i.e. Sample 3 was most flexible). Subsequently, a dental aligner was printed from Sample 3 as a clear and transparent materials. The aligner could be bent or twisted several times without breaking each time recovering its original shape.

### Example 3

Two resin compositions containing different UDMA:PEGDM (molecular weight 1000 g/mol) ratios were used to 3D print rectangular objects (size: 20×10×0.5 mm), using TPO as a photoinitiator (0.5 wt %).

### Sample 1: UDMA:PEGDM=60:40 wt %

### Sample 2: UDMA:PEGDM=50:50 wt %

Both samples produced transparent, colorless objects with significant flexibility and strength. These materials were more flexible than UDMA:PEGDA materials at the sample UDMA wt % (see Example 2). The rectangular pieces were bent by 180 degrees multiple times without breaking.

### Example 4

Two rectangular resin samples (size: 20×10×0.5 mm) were printed using the same printing conditions from the compositions with 30:30:40 and 20:40:40 mass ratios of HEMA:UDMA:EBPADMA. Both samples were very tough and could be fully bended (by 180 degree) a few times before breaking, and the breaking edges were not sharp. They showed also moderate mechanical strength (i.e. not very soft). Subsequently, two aligner samples were printed using the two compositions, respectively. The aligner samples exhibited significant mechanical strength, as well as considerable toughness (i.e., could be moderately twisted).

### Example 5

Resin composition containing UDMA:TEGMA at 50:50 wt % with TPO as photoinitiator were prepared (1 wt %) and used for 3D printing by DLP-SLA printer at 405 nm. The printed objects, rectangle (size: 20×10×0.5 mm) and cone exhibited a slightly yellowish color and were very mechanically hard and brittle (with little flexibility).

### Example 6

An aligner sample was printed using the composition with 50:30:20 mass ratio of HEMA:UDMA:PEGDM (PEGDM: poly(ethylene glycol) dimethacrylate)(molecular weight 950 g/mol). The sample was relatively tough with significant mechanical strength.

### Example 7

Two rectangular resin samples (size: 20×10×0.5 mm) were printed using the same printing conditions from the compositions with 60:40:1 mass ratio of HEMA:UDMA:TPO and 50:10:40:1 mass ratio of HEMA:DMAEMA:UDMA:TPO, respectively. Relative to the brittle resin sample prepared from the composition with HEMA (60 wt %), the resin sample prepared from HEMA (50 wt %)—DMAEMA (10 wt %) monomer combination showed significant toughness.

### Example 8

Multiple resin compositions containing various UDMA:PEGMA (molecular weight 500 g/mol):HEMA ratios were used to 3D print rectangular objects (size: 20×10×0.5 mm), using TPO as a photoinitiator (1 wt %).

### Sample 1: UDMA:PEGMA:HEMA=40:40:20 wt %

### Sample 2: UDMA:PEGMA:HEMA=60:20:20 wt %

### Sample 3: UDMA:PEGMA:HEMA=40:50:10 wt %

### Sample 4: UDMA:PEGMA:HEMA=60:30:10 wt %

### Sample 5: UDMA:PEGMA:HEMA=50:30:20 wt %

### Sample 6: UDMA:PEGMA:HEMA=70:10:20 wt %

All samples produced colorless, transparent objects with varying degree of rigidity and flexibility. Higher amount of UDMA in the composition resulted in harder, less flexible materials. Samples 2, 4 and 6 were the hardest, required the highest amount of force to break, but also exhibited some limited flexibility. Subsequently, clear and colorless dental aligners were printed from Samples 1 and 5.

### Example 9

A resin composition was prepared by adding 10 wt % of silica nano-powder (10-20 nm, from Aldrich) to 50:50:1 mass ratio of HEMA:UDMA:TPO, followed by sonication. The composition was used to 3D-print a rectangular resin sample (size: 20×10×0.5 mm). The resulting resin sample was essentially transparent, and exhibited significant mechanical strength.

### Example 10

The rectangular resin sample (size: 20×10×0.5 mm) printed from 50:48:2:1 mass ratio of HEMA:UDMA:P80:TPO showed very little amount of remaining liquid composition on the sample surface after printing (left figure below), as compared to the control sample without the addition of P80 (right figure below, showing a liquid composition droplet on surface).

### Example 11

The rectangular resin sample (size: 20×10×0.5 mm) printed from 50:30:20:2:1 mass ratio of HEMA:UDMA:PEGDM (molecular weight 950 g/mol):P80:TPO enhanced toughness, as compared to the control sample without the addition of P80. Moreover, an aligner sample was printed from 50:40:10:2:1 mass ratio of HEMA:UDMA:PEGDM (molecular weight 950 g/mol):P80:TPO, and it was relatively tough with significant mechanical strength.

### Example 12

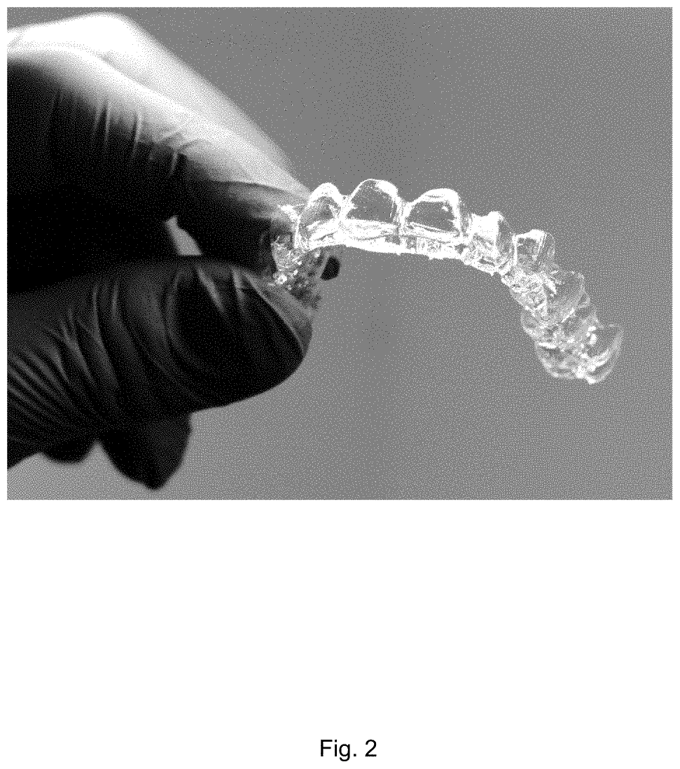

A process for production of dental aligners was developed. Dental aligners were produced using a resin of the present disclosure using a process described herein. An example of a dental aligner formed using a process of the present disclosure is shown in FIG. 2.

### Example 13

Various properties of a dental aligner produced using a resin of the present disclosure were determined.

| Feature/Property | | Testing protocol | result |
|---|---|---|---|
| Layer height | | | 50-100 μm |
| Viscosity of the resin | | | low (e.g., 100-300 cP) |
| Visual | transparency | ASTM D1003-13 | greater than 85% (0.75 |
| | | | mm sample size) |
| Physical | abrasion | e.g. Taber abrasion | |
| | water uptake | 2% strain 37° C./water | less than 0.3% w/w |
| Mechanical | tensile strength/Yield | ISO 527-3 | greater than 25 MPa |
| | | 23(37)° C./water | |
| | elastic modulus | ISO 527-3 | greater than 1600 MPa |
| | | 37° C./water | |
| | elongation at break | ISO 527-3 | greater than 4% |
| | | 37° C./water | |
| | elongation at yield | ISO 527-3 | greater than 4% |
| | | 37° C./water | |
| | tear strength | ISO 6383-1 | 40 N/mm |
| | | 37° C./water | |
| | flexural strength | ISO 178 37° C./water | 10% or justified |
| | impact strength | ISO 180/ASTM D256 | greater than 80 J/m |
| | stress relaxation | 2% strain 37° C./water | 10 h to 50% decrease |
| | ESC (cracks) | user situation | No cracks/2 weeks |
| | stress intensity factor | ISO 20795-2 37° C./water | greater than |
| | | | 4 MPam\hat{ }0, 5 |
| | notched impact strength | ISO 53453-1 | 16 KJK/m² |
| | | 37° C./water | |
| | appearance after break | NA | no splinters/sharp parts |
| Biocompatibility | cytotoxicity | ISO 10993-5 | performed and pass |
| | sensitization | ISO 10993-10 | performed and pass |
| | skin Irritation | ISO 10993-10 | performed and pass |
| | systemic toxicity | ISO 10993-11 | justified acceptance |
| | genotoxicity | ISO 10993 | justified acceptance |

### Example 14

Various biocompatibility properties of a dental aligner produced using a resin of the present disclosure were determined.

Cytotoxicity of a test article formed from a cured a resin of the present disclosure was determined. The Minimal Essential Media (MEM) Elution test was designed to determine the cytotoxicity of extractable substances. An extract of the test article was added to cell monolayers and incubated. The cell monolayers were examined and scored based on the degree of cellular destruction. All test method acceptance criteria were met. Testing was performed in compliance with US FDA good manufacturing practice (GMP) regulations 21 CFR Parts 210, 211 and 820.

The test results follow:

| | | | | | | | Amount Tested/ |
|---|---|---|---|---|---|---|---|
| | Results | Scores | | | | | Extraction Solvent |
| Dilution | Pass/Fail | #1 | #2 | #3 | Average | Extraction Ratio | Amount |
| Neat | Pass | 2 | 2 | 2 | 2 | 3 cm²/mL | 80.7 cm²/26.9 mL |
| 1:2 | Pass | 1 | 1 | 1 | 1 | | |
| 1:4 | Pass | 0 | 0 | 0 | 0 | | |
| 1:8 | Pass | 0 | 0 | 0 | 0 | | |
| 1:16 | Pass | 0 | 0 | 0 | 0 | | |

Controls:

| | | | | | | Amount Tested/ |
|---|---|---|---|---|---|---|
| | Scores | | | | | Extraction Solvent |
| Identification | #1 | #2 | #3 | Average | Extraction Ratio | Amount |
| Negative Control - | 0 | 0 | 0 | 0 | 0.2 g/mL | 4 g/20 mL |
| Polypropylene Pellets | | | | | | |
| Media Control | 0 | 0 | 0 | 0 | N/A | 20 mL |
| Positive Control - | 4 | 4 | 4 | 4 | 0.2 g/mL | 4 g/20 mL |
| Latex Natural Rubber | | | | | | |

Test Method Acceptance Criteria. The United States Pharmacopeia & National Formulary (USP <87>) states that the test article meets the requirements, or receives a passing score (Pass) if the reactivity grade is not greater than grade 2 or a mild reactivity. The ANSI/AAMI/ISO 10993-5 standard states that the achievement of a numerical grade greater than 2 is considered a cytotoxic effect, or a failing score (Fail).

The acceptance criteria was based upon the negative and media controls receiving “O” reactivity grades and positive controls receiving a 3-4 reactivity grades (moderate to severe). The test was considered valid as the control results were within acceptable parameters.

The cell monolayers were examined microscopically. The wells were scored as to the degree of discernable morphological cytotoxicity on a relative scale of O to 4:

| Conditions of All Cultures | Reactivity | Grade |
|---|---|---|
| No cell lysis, intracytoplasmic granules. | None | 0 |
| Less than or equal to 20% rounding, occasional lysed cells. | Slight | 1 |
| Greater than 20% to less than or equal to 50% rounding, no | Mild | 2 |
| extensive cell lysis. | | |
| Greater than 50% to less than 70% rounding and lysed cells. | Moderate | 3 |
| Nearly complete destruction of the cell layers. | Severe | 4 |

The results from the three wells were averaged to give a final cytotoxicity score.

Procedure. The amount of test material extracted was based on ANSI/AAMI/ISO and USP surface area or weight recommendations. Test articles and controls were extracted in 1× Minimal Essential Media with 5% bovine serum for 72±2 hours at 37±1° C. with agitation. Multiple well cell culture plates were seeded with a verified quantity of industry standard L-929 cells (ATCC CCL-1) and incubated until approximately 80% confluent. The test extracts were held at room temperature for less than four hours before testing. The extract fluids were not filtered, centrifuged or manipulated in any way following the extraction process. The test extracts were added to the cell monolayers in triplicate. The cells were incubated at 37±1° C. with 5±1% CO₂ for 48±3 hours.

Pre and Post Extract Appearance

| | | |
|---|---|---|
| Test Articles | Pre extract | Clear with no particulates present |
| | Post extract | Clear with no particulates present. No color |
| | | change noted. |
| Controls | Pre extract | Clear with no particulates present |
| | Post extract | Clear with no particulates present. No color |
| | | change noted. |

Intracutaneous testing of a test article formed from a cured a resin of the present disclosure was carried out.

| | | | |
|---|---|---|---|
| Test Article | | Ratio | 3 cm² / mL |
| | | Vehicles | USP 0.9% Sodium Chloride |
| | | | for Injection (NaCl) and |
| | | | Cottonseed Oil (CSO) |
| Study | Intracutaneous Injection | Extraction | 50 ± 2° C. for 72 ± 2 hours |
| | Test - ISO | Conditions | |

| | |
|---|---|
| Comments | Color: Clear |
| | Physical State: Insoluble |
| | Sterility: Not Sterile |
| | Storage Condition: Room Temperature |
| | Two arches were pooled to equal one sample for testing. The test article |
| | was extracted intact. |

The study was conducted based upon the following references: ISO 10993-10, 2010, Biological Evaluation of Medical Devices—Part 10: Tests for Irritation and Skin Sensitization; ISO 10993-12, 2012, Biological Evaluation of Medical Devices—Part 12: Sample Preparation and Reference Materials; and ISO/IEC 17025, 2017, General Requirements for the Competence of Testing and Calibration Laboratories.

General Procedure. The Intracutaneous Test is designed to evaluate local responses to the extracts of test articles, following intracutaneous injection into rabbits. The extraction conditions were performed as stated above. Control extracts were prepared in a similar manner with each extracting medium. A volume of 0.2 mL per site of the test article extract was injected intracutaneously at one side of each of three rabbits, five sites for the test article extract and five posterior sites for the control. The injected sites were examined immediately after injection and at 24±2 hours, 48±2 hours, and 72±2 hours post inoculation for gross evidence of tissue reaction such as erythema, edema, and necrosis. Observations were scored according to the Classification System for Scoring Skin Reactions and included all clinical signs. All average erythema and edema scores for the test and control sites at 24±2 hours, 48±2 hours, and 72±2 hours were totaled separately and divided by 15 (3 scoring time points×5 test or vehicle control injection sites) to determine the overall mean score for the test article versus the corresponding control article. The requirements of the test are met if the difference of the mean reaction score (erythema/edema) for the test article and the control article is 1.0 or less.

All of the test animals increased in weight. None of the animals exhibited overt signs of toxicity at any of the observation points. The requirements of the test were met because the difference of the mean reaction score for the test and control articles was 0.0.

The test article met the requirements of the Intracutaneous Test, ISO 10993-10 guidelines using extracts prepared with NaCl and CSO.

Kligman Maximization testing of a test article formed from a cured a resin of the present disclosure was carried out,

| | | | |
|---|---|---|---|
| Test Article | | Ratio | 3 cm²/mL |
| | | Vehicles | USP 0.9% Sodium Chloride |
| | | | for Injection (NaCl) and |
| | | | Cottonseed Oil (CSO) |
| Study | Kligman Maximization | Extraction | 50 ± 2° C. for 72 ± 2 hours |
| | Test - ISO | Conditions | |

| | |
|---|---|
| Comments | Physical State: Insoluble |
| | Color: Clear |
| | Sterility: Not Sterile |
| | Storage Condition: Room Temperature |
| | Two arches were pooled to equal one sample for testing. The test article |
| | was extracted intact. |

The study was conducted based upon the following references: ISO 10993-10, 2010, Biological Evaluation of Medical Devices—Part 10: Tests for Irritation and Skin Sensitization. United States Pharmacopeia 41, National Formulary 36, 2018. <1184> Sensitization Testing. Zhai, H., Wilhem, K-P, and H. I. Maibach, eds. Marzulli and Maibach's Dermatotoxicology. 7th edition Boca Raton: CRC Press, 2007. 443-444, 450-451. Magnusson, B. and A. M. Kligman. “The Identification of Contact Allergens by Animal Assay. The Guinea Pig Maximization Test.” J. Invest. Dermatol. 52 (1969): 268-276. Magnusson, B. and A. M. Kligman, Allergic Contact Dermatitis in the Guinea Pig. Identification of Contact Allergens. Springfield, Ill.: Thomas, 1970. ISO 10993-12, 2012, Biological Evaluation of Medical Devices—Part 12: Sample Preparation and Reference Materials. ISO/IEC 17025, 2017, General Requirements for the Competence of Testing and Calibration Laboratories.

General Procedure. The purpose of the study was to detect the allergenic potential of a test article. Hartley guinea pigs, 20 experimental, 10 negative control, and 5 positive control, were used for this study. The test article was extracted at the conditions specified above. The Induction Phase (Day 0) was conducted by intradermally injecting the test article extracts or controls. The Topical Application Phase (Day 7) was conducted by applying the test article extract or control article for 48 hours, at the site of the intradermal injections. The 24 hour Challenge Phase was performed on Day 23. Test and control animals were scored for erythema and edema according to the Magnusson and Kligman Scale at 24, 48, and 72 hours post Challenge Phase. The study and its design employed methodology to minimize uncertainty of measurement and control or bias for data collection and analysis.

The skin sites that were exposed to the test article extracts and negative control showed no signs of erythema or edema. The skin sites exposed to the positive control showed the expected signs of erythema and edema.

The skin treated with the test article extracts exhibited no reaction to the challenge (0% sensitization). Therefore, as defined by the grading scale of the USP, the test article was classified as a non-sensitizer.

Although the present disclosure has been described with respect to one or more particular embodiments and/or examples, it will be understood that other embodiments and/or examples of the present disclosure may be made without departing from the scope of the present disclosure.

1. A resin composition comprising:
one or more photoinitiator;
one or more hard cross-linker, wherein the one or more hard cross-linker has at least two reactive groups and is present at 20-75 wt % (based on the total weight of the composition); and
one or more soft cross-linker and/or one or more reactive diluent, wherein the one or more soft cross-linker has at least two reactive groups is present at 2-70 wt % (based on the total weight of the composition) and/or the one or more reactive diluent has only one reactive group and is present at 2-70 wt % (based on the total weight of the composition).

2. The resin composition of claim 1, wherein the resin composition further comprises one or more soft cross-linker and one or more reactive diluent.

3. The resin composition of claim 1, wherein the resin composition further comprises:
one or more filler; and/or
one or more additive.

4. The resin composition of claim 1, wherein the one or more photoinitiator is diphenyl(2,4,6-trimethylbenzoyl)phosphine oxide (TPO), 1-phenyl-1,2-propanedione/triame (PPD/TA), camphoroquinone, Irgacure 819, henanthrenequinone, or a combination thereof.

5. The resin composition of claim 1, wherein the hard cross-linker has a molecular weight of less than 700 g/mol and, optionally, one or more aromatic group, and/or one or more hydrogen-bonding group.

6. The resin composition of claim 1, wherein the one or more hard cross-linker is UDMA (bis(2-methacryloxyethyl) N, N′-1, 9-nonylene biscarbamate), bisphenol A or a derivative thereof, pyromellitic dianhydrate dimethacrylate, or a combination thereof.

7. The resin composition of claim 1, wherein the soft cross-linker when polymerized to a molecular weight (Mw and/or Mn) of 8,000-15,000 g/mol provides a polymer having a glass transition temperature (Tg) of 30° C. or less.

8. The resin composition of claim 1, wherein the one or more soft cross-linker is polyethylene glycol dimethacrylate (PEGDM), polyethylene glycol diacrylate (PEGDA), polypropylene glycol dimethacrylate (PPGDMA), polypropylene glycol diacrylate (PPGDA), bisphenol A ethoxylate diacrylate (EBPADA) having a molecular weight of 700 g/mol or greater, bisphenol-A ethoxylate dimethacrylate (EBPADMA) having a molecular weight of 700 g/mol or greater, tetraethylene glycol dimethacrylate (TEGDMA), polydimethyl siloxane dimethacrylate (PDMSDMA), polydimethyl siloxane diacrylate (PDMSDA), or a combination thereof.

9. The resin composition of claim 1, wherein the one or more reactive diluent is chosen from acrylamides, methacrylamides, acrylates, methacrylates, and combinations thereof.

10. The resin composition of claim 1, wherein the one or more reactive diluent is 2-hydroxyethyl methacrylate (HEMA), polyethylene glycol methacrylate (PEGMA), polyethylene glycol acrylate (PEGA), (2-dimethylaminoethyl) methacrylate (DMAEMA) or a combination thereof.

11. The resin composition of claim 1, wherein the one or more filler is a plurality of nanoparticles having no dimension greater than 100 nm.

12. The resin composition of claim 1, wherein the one or more additive is a photoblocker, surfactant/wetting agent, or a combination thereof.

13. The resin composition of claim 1, wherein the one or more filler is present at 0.1-20 wt % (based on the total weight of the composition) and/or the one or more additive is present at 0.5-5 wt % (based on the total weight of the composition).

14. The resin composition of claim 1, wherein the mass ratio of the one or more soft cross-linker to the one or more hard cross-linker is 1:9 to 9:1.

15. (canceled)

16. (canceled)

17. The resin composition of claim 1, wherein the composition has a viscosity of 1 to 2000 cP at room temperature.

18. (canceled)

19. (canceled)

20. (canceled)

21. A three-dimensional (3D) printed article of manufacture exhibiting one or more or all of the following:
a Young's modulus of at least at least 1 GPa;
a tensile strength of at least 20 MPa; and
an ultimate elongation of at least 4%.

22. The 3D printed article of manufacture of claim 21, exhibiting greater than 85% transmittance measured under ASTM D1003-13 using a 0.75 mm sample size, wherein the sample size is measured along the optical path the light is transmitted through the sample.

23. The 3D printed article of manufacture of claim 21, exhibiting a fracture toughness of greater than 80 J/m as measured under ISO180 and/or ASTM D256.

24. (canceled)

25. The 3D printed article of manufacture of claim 21, wherein the 3D printed article of manufacture exhibits one or more or all of the following:
a tensile strength/yield greater than 20 MPa measured under ISO 527-3, wherein the tensile strength/yield is measured at 23 to 37° C. in water;
an elastic (Young's) modulus greater than 1600 MPa measured under ISO 527-3, wherein the elastic (Young's) modulus is measured at 37° C. in water;
an elongation at break greater than 4% measured under ISO 527-3, wherein the elongation at break is measured at 37° C. in water;
an elongation at yield greater than 4% measured under ISO 527-3, wherein the elongation at yield is measured at 37° C. in water;
a tear strength of 40 N/mm or greater measured under the requirements of ISO 6383-1, wherein the tear strength is measured at 37° C. in water;
a flexural strength of 10% or justified measured under ISO 178, wherein the flexural strength is measured at 37° C. in water;
an impact strength of greater than 80 J/m measured under ISO 180 and/or ASTM D256;
a stress intensity factor greater than 4 MPa*m^{0.5} measured under ISO 20795-2, wherein the stress intensity factor is measured at 37° C. in water;
a notched impact strength of 16 KJK/m² measured under ISO 53453-1, wherein the notched impact strength is measured at 37° C. in water;
a cytotoxicity at least meeting the requirements of ISO 10993-5;
a sensitization at least meeting the requirements of ISO 10993-10;
a skin irritation at least meeting the requirements of ISO 10993-10;
a systemic toxicity at least meeting the requirements of ISO 10993-11; or
a genotoxicity at least meeting the requirements of ISO 10993.

26. (canceled)

27. The 3D printed article of manufacture of claim 21, wherein the object is a dental object, hearing aid, or sleep apnea device.

28. (canceled)

29. (canceled)

30. A method of making a three-dimensional (3D) article of manufacture comprising:
a) exposing a first layer of a resin composition of claim 1 to electromagnetic radiation having a wavelength of 350-420 nm such that at least a portion of the first layer of a resin composition reacts to form a polymerized portion of the first layer;
b) optionally, forming a second layer of a resin composition claim 1 disposed on at least a portion of the polymerized portion of the previously formed polymerized portion and exposing the second layer of a resin composition to electromagnetic radiation having a wavelength of 350-420 nm such that at least a portion of the second layer of a resin composition reacts to form a second polymerized portion of the second layer disposed on the polymerized portion of the first layer; and
c) optionally, repeating the forming and exposing from b) a desired number of times,
wherein the 3D article of manufacture is formed.

31. (canceled)

32. (canceled)

33. (canceled)
